(19) United States
(12) Patent Application Publication
(10) Pub. No.: US 2022/0094013 A1
(43) Pub. Date: Mar. 24, 2022

(54) AUTOMATIC VENTING SAFETY ENCLOSURE FOR GRID-STORAGE BATTERIES

(71) Applicant: BATTELLE MEMORIAL INSTITUTE, Richland, WA (US)

(72) Inventor: Matthew D. Paiss, Soquel, CA (US)

(73) Assignee: BATTELLE MEMORIAL INSTITUTE, Richland, WA (US)

(21) Appl. No.: 17/483,202

(22) Filed: Sep. 23, 2021

Related U.S. Application Data
(60) Provisional application No. 63/082,680, filed on Sep. 24, 2020.

(51) Int. Cl. H01M 50/375; H01M 10/42

(52) U.S. Cl. CPC H01M 50/375; H01M 10/425

(57) ABSTRACT

A system including a container defining a chamber in which an energy storage device is housed contains openings in the sides of the container dimensioned to be covered with doors connected to opening mechanisms that open the door when a latching mechanism is released as a result of a signal received from any of a variety of sensors and take selected action based upon that preselected signal. Monitoring and selective opening of the doors to allow venting allows for preventing fires and explosions is enabled by such a system and device.

### PRIORITY

This application claims priority from and incorporates in its entirety by reference U.S. Provisional Patent Application No. 63/082,680 entitled Automatic Exhaust Doors filed on Sep. 24, 2020.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### FIELD OF THE INVENTION

The invention generally relates to containers for electrochemical storage devices and more particularly to improving safety for such containers by selectively exhausting flammable gasses.

### BACKGROUND INFORMATION

In a world of ever-changing climate challenges utilization and deployment of renewable energy sources such as wind, water, tidal and solar are of increasing interest. One of the issues with many of these types of renewable energy systems is a need to be able to store large amounts of power for deployment into traditional energy distribution systems such as an electric grid. One of the issues that continues to arise with these energy storage systems is the risk of fire and explosion that occurs with these devices as they are in use. Many fire codes require that any enclosure housing such a system be capable of mitigating explosion risks in the event of a catastrophic failure of the battery inside the enclosure. Generally, this is done by providing deflagration panels that will be blown out in an explosion. While this may protect the building, it would not prevent an explosion in the first place.

In some locations this may be unsuitable as the risk of flying panels or debris introduces other elements and limits the locations in which the storage units can be placed. In addition, simply blowing out a panel and allowing it to burn may create other environmental hazards and concerns. Another is option is to attempt to prevent the accumulation of flammable gasses within an enclosed space by using a venting system such as an exhaust fan.

However, as newer trends in the design of these enclosures are moving from a shipping container-type design with man-doors to access the systems from the interior, to a cabinet-type design with exterior doors to access the energy storage systems from the exterior of the cabinet these venting systems are less and less favored. This exterior access cabinet designs allow more batteries to be installed and simplifies access from the exterior. This arrangement, however, presents additional challenges in that there is now less room for exhaust fans and a greater need to ventilate the smaller empty volume within the cabinet. There are currently no products available to address this issue.

The present disclosure provides examples of devices and systems that attempt to address these problems by providing a way for explosive and volatile vapors to be removed in response to preselected signals. By so doing the risk of explosion and damage is significantly mitigated and increased utilization of such energy storage devices is enhanced. This provides a number of advantages related not only to the immediate safety of the device but also increased utilization of energy storage devices in conjunction with renewable energy transformation devices reducing the carbon footprint and acting as a mitigating factor against worldwide global impacts of global warming.

Additional advantages and novel features of the present invention will be set forth as follows and will be readily apparent from the descriptions and demonstrations set forth herein. Accordingly, the following descriptions of the present invention should be seen as illustrative of the invention and not as limiting in any way.

### SUMMARY

The present disclosure provides examples of systems, methods and devices for selectively intelligently venting exhaust gasses from electrochemical storage devices and systems. In one example, a system is described wherein a container having a frame including a a top, bottom, and a plurality of supports positioned between the top and bottom to define sides form a chamber in which an energy storage device is housed. Access to the energy storage devices is made possible through openings defined in the sides of the container which contain openings dimensioned to allow access to the electrochemical storage devices. These openings are typically each covered with a door which is connected to an opening mechanism designed to open the door when a latching mechanism is released based upon a signal received from a command module which is configured to receive inputs from any of a variety of sensors and take selected action based upon that preselected signal.

In operation a sensor such as a smoke detector receives a signal and transmits a signal to the command module which then sends a signal to the latch to trigger a release. When this happens, the opening mechanism opens the doors covering the openings and the gas, smoke or other material is vented out of the cabinet. The type of signal to be received by the sensor may vary as may the timing and response by the command module and other sensors and type of conditions may also be taken into consideration as a part of a preferred deployment. While various examples of elements of the previously described system and device are provided hereafter, this list is not intended to be exhaustive or limiting of the invention.

In one embodiment, the door is connected to the frame by a hinge, and depending upon the needs of the user a number of doors of differing dimensions can be utilized to provide the appropriate level of protection and access for the particular desired configuration. Preferably, two or more doors are utilized, including one on each opening. Each door is dimensioned and positioned to cover the opening in a first position and to uncover the opening in a second position. The second position can be the position where the door fully uncovers the opening or it can be the position where the door less than fully uncovers the opening. In one embodiment, the opening mechanism is a gas strut located within the chamber and connected to the frame. However, a variety of other configurations of opening mechanisms both internal and external are also contemplated including but not limited gravity operated such as weights, pulleys and pivots, electromechanical actuators, hydraulic systems and the like.

Preferably the latching mechanism is put in place to keep the door closed. Preferably this latching mechanism connects the frame and the door and is configured to releasably hold the door closed in the previously described first position until activated to release the latch and allow the opening mechanism to open the door. In one embodiment, the latching mechanism is a magnetic latch that, when triggered, allows the opening mechanism to door to move the door from the closed first position to a preselected the second position, which may vary to uncover any or all of the opening over which the door is placed.

A command device is operatively connected to the latching mechanism and controls the engagement or release of the latching mechanism and hence the opening or retention of the door to cover the opening. The command device is configured to receive a preselected input from at least one of a plurality of sources and trigger the latching mechanism upon receipt of that input. In one embodiment, the source is selected from the group consisting of a fire control system, such as a heat or smoke detector, a gas sensor such as a carbon monoxide sensor, or the like and a manual entry device, such as a key pad. In one embodiment, a fire control system sensor may be positioned near a vent positioned on the top or sides of the container.

The arrangement described allows for the safe operation of energy storage systems by allowing selective ventilation of confined spaces containing energy storage systems based upon detection of a non-desired condition and initiation of a mitigating action to change the environment surrounding the energy storage device. This intelligent venting arrangement allows for increased safety and better adoption of energy storage systems particularly those of the grid scale energy storage size.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions I have shown and described only the preferred embodiment of the invention, by way of illustration of the best mode contemplated for carrying out the invention. As will be realized, the invention is capable of modification in various respects without departing from the invention. Accordingly, the drawings and description of the preferred embodiment set forth hereafter are to be regarded as illustrative in nature, and not as restrictive.

### BRIEF DESCRIPTION OF THE DRAWINGS

FIG. 1 is a perspective side view of one embodiment of the invention.

FIG. 2 is a cut away of the embodiment shown in FIG. 1 showing the placement of various electrochemical storage devices within the chamber.

FIG. 3 is a perspective side view of one embodiment of the invention.

FIG. 4 is a detailed front view of the door along with operatively and physically connected components.

FIG. 5 is a logic table actions to be taken based upon the sensing of a particular condition and the opening the doors for appropriate venting.

### DETAILED DESCRIPTION OF THE INVENTION

The following description includes the preferred best mode of one embodiment of the present invention. It will be clear from this description of the invention that the invention is not limited to these illustrated embodiments but that the invention also includes a variety of modifications and embodiments thereto. Therefore, the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

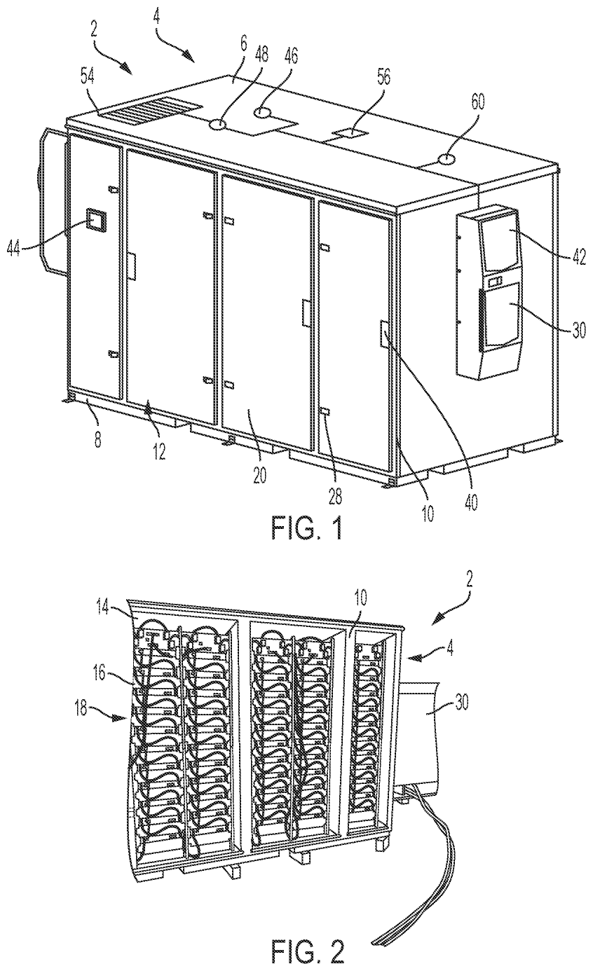

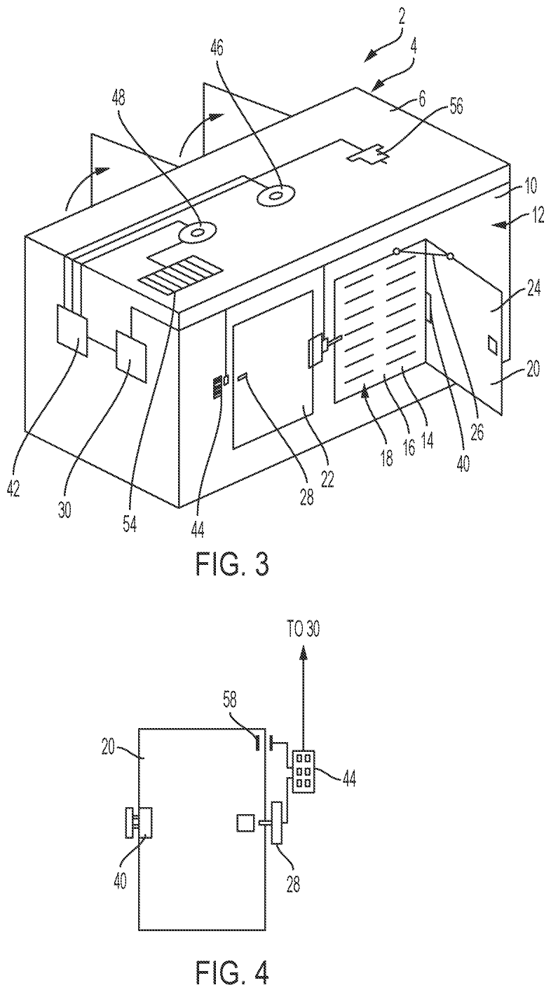

FIGS. 1-5 show a variety of embodiments and configurations of the present invention. While these particular arrangements are shown and described it is to be distinctly understood that the invention is not limited to these particular arrangements but may be variously embodied to include any of a variety of additional elements.

Referring first to FIG. 1 a first view of one embodiment of the present invention is shown. In this embodiment of the invention a container 2 for an electrochemical storage device 18 is described. The container 2 has a frame 4 made up of a top 6, bottom 8, and a plurality of supports 10 connecting the top 6 and the bottom 8 defining sides 12. The container 2 has at least one side 12 that defines an opening 14 dimensioned to permit access to a chamber 16 defined within the frame 4. This chamber 16 is configured to hold the electrochemical storage device 18, which may consist of one or a number of stacks or modules. Preferably, the two or more sides 12 define openings 14 each opening configured to allow access to at least a portion but preferably the entire side of an energy device module or system. While no limitations are intended upon the intelligent venting system described in this application, preferred applicability has been shown in larger cabinets and contained having a a volume greater than about a cubic meter.

Preferably, the container 2 has at least one door 20 on at least one side 12 of the frame 4, the door 20 connected to the frame 4. In one embodiment, the door 20 is connected to the frame 4 by a hinge 40. In one embodiment, the container 2 has two or more doors 20, including one on each opening 14. The door 20 is dimensioned and positioned to cover the opening 14 in a first position 22 and to uncover the opening 14 in a second position 24. In one embodiment, the door 20 fully uncovers the opening 14 in the second position 24.

The container 2 also has an opening mechanism 26 configured to open the door 20. In one embodiment, the opening mechanism 26 is a gas strut that is located within the chamber 16 and connected to the frame 4. However, a variety of other configurations of opening mechanisms both internal and external are also contemplated including but not limited gravity operated such as weights, pulleys and pivots, electromechanical actuators, hydraulic systems and the like.

The container 2 further has a latching mechanism 28 connecting the frame 4 and the door 20 wherein the latching mechanism 28 is configured to releasably hold the door 20 closed in the first position 22. In one embodiment, the latching mechanism 28 is a magnetic latch that, when triggered, allows the door 20 to open to move to the second position 24. The container 2 also has a command device 30 operatively connected to the latching mechanism 28. The command device 30 is configured to receive an input from at least one of a plurality of sources and trigger the latching mechanism 28 upon receipt of the input. In one embodiment, the source is selected from the group consisting of a fire control system 42 and a manual entry device 44. In one embodiment, the manual entry device 44 is a keypad that can be numerical. In one embodiment, the fire control system 42 is operatively connected to the command device 30 and has a heat detector 46 and a smoke detector system 48. In one embodiment, the container 2 also has a vent 54 operatively connected to the smoke detector system 48. More detailed views are shown in FIGS. 2, 3, and 4.

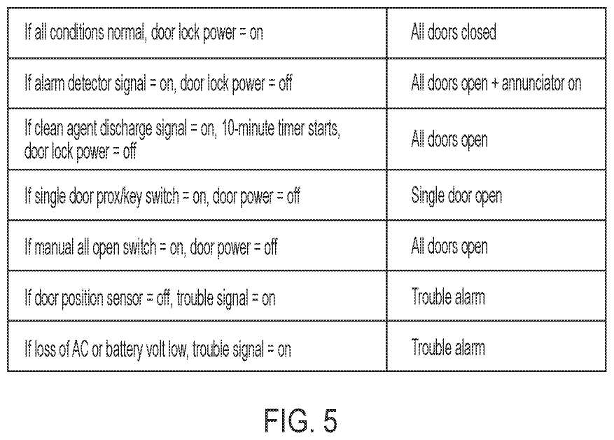

While most methods of mitigating explosion risks involve directing the explosive blast or venting a relatively small amount of gases, our novel solution rapidly ventilates a large amount of gases to quickly mitigate the risk of explosion. By allowing the existing doors 20 to function as an automatic ventilation opening, any accumulation of flammable gases will be passively exhausted to the outdoors, minimizing the potential for an explosion. Providing an automatic method for all doors 20 to open simultaneously based on an input from a variety of sources or manual activation can reduce these risks to personnel and in addition allow better access for firefighters to direct hose streams from a safe distance for extinguishment. This would be beneficial for the applications of outdoor energy storage systems (ESS) installations. It would meet the intent of the code requirements for deflagration prevention in both the International Fire Code (sec 1206.6.3) as well as NFPA 855 (sec 4.12). A basic logic diagram of the approach utilized is shown in FIG. 5, and a detailed wiring diagram is shown in FIG. 6.

In one embodiment, the latching mechanism 28 is fail-safe. Under normal operation a 24 Vdc signal is sent to the latching mechanism 28 to hold the door 20 in the first position 22. When a loss of power is experienced, the latching mechanism 28 releases, allowing the door 20 to open to the second position 24 under the power of the opening mechanism 26. The command device 30 is equipped with normally open (NO) and normally closed (NC) contacts to support input from a variety of sources such as smoke, heat, or gas detection. If a clean agent system 56 is utilized, the system would monitor the heat detector 46 after a designed soak time of the clean agent system 56 to detect a trending up temperature, signifying failure of clean agent system 56 to suppress the fire.

In one embodiment, a logic arrangement is utilized in the command device 30 wherein various actions are taken based upon various inputs. If all conditions are normal, the latching mechanism 28 power stays on and all doors 20 remain in the first position 22. If the smoke detector system 48 signal is on, the latching mechanism 28 power is turned off and the doors open to the second position 24. If the gas detector 60 signal is on, the latching mechanism 28 power is turned off and the doors open to the second position 24. If the clean agent system 56 discharge signal is on, a timer starts and a cleaning protocol is executed. If a heat detector 46 activates, power to the latching mechanism 28 is turned off and the doors 20 are opened to the second position 24. If a single door 20 is opened, a door sensor 58 is activated and the latching mechanism 28 power is also shut off and the other doors 20 open to the second position 24 as well. In addition to the automatic options described previously, activation of the manual entry device 44 can also deactivate the latching mechanism 28 and cause the doors 20 to open to the second position 24. If desired, a number of other alerts, alarms, and actions may be taken to address the concerns in place at the time.

While this particular configuration is shown and described the general process under which the system operates can be addressed with any of a number of particular items so long as they are interconnected to perform the basic functions of sensing a particular condition, sending a signal to ventilate the cabinet based upon that condition and triggering the venting of the cabinet. A basic overview of the steps and logic chart are shown in FIG. 5.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

We claim:

1. A system for protecting an electrochemical storage device comprising:
a container having a frame comprising a top, a bottom, and a plurality of supports connecting the top and the bottom defining sides, at least one side defining an opening configured to permit access to a chamber defined within the frame, wherein the chamber is configured to hold the electrochemical storage device;
at least one door on at least one side of the frame, the door connected to the frame, the door dimensioned and positioned to cover the opening in a first position and to uncover the opening in a second position;
an opening mechanism configured to open the door;
a latching mechanism connecting the frame and the door configured to hold the door closed in the first position; and
a command device operatively connected to the latching mechanism, the command device configured to receive an input from at least one of a plurality of sources and trigger the latching mechanism upon receipt of the input.

2. The system of claim 1 wherein the opening mechanism is a gas strut.

3. The system of claim 2 wherein the latching mechanism is a magnetic latch that, when triggered, allows the door to move to the second position.

4. The system of claim 3 comprising at least two doors.

5. The system of claim 4 wherein at least two sides define openings.

6. The system of claim 5 wherein the door is connected to the frame with a hinge.

7. The system of claim 6 wherein the opening is fully uncovered when the door is in the second position.

8. The system of claim 6 wherein the opening is less than fully uncovered when the door is in the second position.

9. The system of claim 1 wherein the source is selected from the group consisting of a fire control system and a manual entry device.

10. The system of claim 9 wherein the command device is operatively connected to the fire control system.

11. The system of claim 10 wherein the fire control system comprises a heat detector and a smoke detector system.

12. The system of claim 11 further comprising a vent operatively connected to the smoke detector system.

13. A system for protecting an electrochemical storage device comprising:
a container comprising a frame comprising a top, a bottom, and a plurality of supports connecting the top and the bottom defining sides, at least one side defining an opening configured to permit access to a chamber defined within the frame, wherein the chamber is configured to hold the electrochemical storage device;
at least one door on at least one side of the frame, the door connected to the frame by a hinge, the door dimensioned and positioned to cover the opening in a first position and to fully uncover the opening in a second position;
a latch connecting the frame and the door, the latch configured to releasably hold the door closed in the first position;
an opening mechanism connected to the door and configured to open the door when the latch is released; and
a command device operatively connected to the latch, the command device configured to receive an input from at least one of a plurality of sources and release the latch upon receipt each of the input.

14. The system of claim 13 wherein at least two sides define openings, the container comprising at least one door on each of the openings.

15. The system of claim 14 wherein the latch is a magnetic latch.

16. The system of claim 15 wherein the opening mechanism is a gas strut, the gas strut located within the chamber and connected to the frame.

17. The system of claim 16 wherein the frame has a volume greater than about a cubic meter.

18. The system of claim 13 wherein the source is selected from the group consisting of a smoke detector system, a heat detector, and a keypad.

19. The system of claim 18 further comprising a vent operatively connected to the smoke detector system.

20. A container, having a volume greater than about a cubic meter, for an electrochemical storage device comprising:
a frame comprising a top, a bottom, and a plurality of supports connecting the top and the bottom defining sides, at least two sides defining openings configured to permit access to a chamber defined within the frame, wherein the chamber is configured to hold the electrochemical storage device;
at least one door on each of at least two sides of the frame, each door connected to the frame by a hinge, each door dimensioned and positioned to cover the opening in a first position and to fully uncover the opening in a second position;
a magnetic latch connecting the frame and the door, the latch configured to releasably hold the door closed in the first position;
a gas strut located within the chamber, the gas strut connected to the door and to the frame and configured to open the door when the magnetic latch is released; and
a command device operatively connected to the magnetic latch, the command device configured to receive an input from at least one of a plurality of sources including a smoke detector system, a heat detector, and a numerical keypad and release the magnetic latch upon receipt of the input, the smoke detector system further operatively connected to a vent.
